(19) United States
(12) Patent Application Publication
(10) Pub. No.: US 2004/0143918 A1
(43) Pub. Date: Jul. 29, 2004

(54) Multi-part single-use toothbrush system

(76) Inventors: Clyde Blackman, Ventura, CA (US); Ray Colletti, Thousand Oaks, CA (US)

Correspondence Address: BRIGHT & LORIG, Ste. 3330, 633 West Fifth Street, Los Angeless, CA, 90071, US

(21) Appl. No.: 10/353,442

(22) Filed: Jan. 29, 2003

(51) Int. Cl. A61C 17/26; A61C 17/34

(52) U.S. Cl. 15/28; 15/22.1; 15/176.1

(57) ABSTRACT

A multi-part single-use toothbrush system comprises an electric toothbrush such as a rotary electric toothbrush, a plurality of disposable toothbrush heads, each with dentifrice sufficient for a single tooth brushing use, and each with a connector for attachment to and detachment from the electric toothbrush, and a dispenser for holding and dispensing such disposable toothbrush heads.

This invention relates to a multi-part, single-use/disposable head toothbrush system that comprises: an electric toothbrush, preferably a rotary or oscillating electric toothbrush; a disposable toothbrush head with bristles bearing dentifrice sufficient for a single tooth-brushing use, and with a connector for attachment to and detachment from the electric toothbrush; and, in preferred embodiments, a dispenser for holding and dispensing disposable toothbrush heads.

The electric toothbrush may, in some embodiments, have replaceable or rechargeable batteries, or both. The toothbrush also comprises a connector such as a spindle arrangement to connect to a brush-head that can rotate or oscillate the bristle-head through about 90° or about 360°.

The toothbrush heads comprise bristles, preferably soft, rounded and polished bristles, and a connector for attachment to the rotating or oscillating part of the electric toothbrush. The brush heads carry dentifrice in a quantity sufficient for a single tooth-brushing use, thus eliminating the need for toothpaste, or other dentifrice, and the need for dispensers for toothpaste and other dentifrices.

In preferred embodiments, the system includes a dispenser for the brush-heads that releases/dispenses a desired number of brush-heads, preferably one at a time, and holds a plurality of such heads, e.g. heads of the same kind, or heads of different kinds.

In some embodiments, each brush head is impregnated with dentifrice so that during brushing and penetration by the brush bristles, the dentifrice is delivered to desired areas. Preferably, the brush has soft rounded and polished bristles with space between bristles for accommodating a single use quantity of dentifrice. This dentifrice may be applied to the brush through impregnation. The dentifrice is released during brushing.

Since the dentifrice is contained within the brush, abrasion or other mishandling/rough handling of the brush heads, during packaging or otherwise, does not remove the dentifrice until the dentifrice contacts a material such as saliva, water or mouth rinse which can dissolve and/or release the dentifrice from the bristles. Since the dentifrice is not chemically bonded to the bristles, the dentifrice can be removed through contact with water, saliva or physical contact during brushing and thus is released on contact with teeth and gums.

Many different brush configurations are useful in this system. The invention therefore is not limited to any particular toothbrush head configuration.

Generally, the sizing of the brush tip and amount of dentifrice disposed on the bristles is such that essentially a single use will release substantially all the dentifrice. Thereafter the brush will be disposed of and replaced by a second dentifrice-carrying brush.

One alternative for incorporating dentifrice in the bristles is by solvent impregnation and drying. Impregnation may also occur through dipping or spraying. Another alternative for delivering dentifrice is to include a plurality of hollow bristles, rather than solid bristles in the brush tip and to draw the dissolved dentifrice into the individual bristles. Another alternative is the use of extremely absorptive bristle materials, similar to a sponge, or incorporating the dentifrice into the bristles before construction of the brush tip.

This multi-part system eliminates auto-contamination of toothbrush heads; eliminates communal contamination of toothpaste; eliminates damage to gingiva and dental structures caused by using damaged/old toothbrush bristles; and provides a practical, workable, and inexpensive alternative to other toothbrush systems.

Most toothbrushes are unsuitable to use around bridges or tooth furcations. This system may include a plurality of different brush-heads to clean such areas.

### BRIEF DESCRIPTION OF THE DRAWINGS

The system can be better understood by reference to the drawings, in which:

FIG. 1 is a side elevation view of an electric toothbrush that forms part of one embodiment of the system;

FIG. 2 shows a side elevation view of a single-use toothbrush head carrying a dentifrice such as toothpaste and including a connector for attachment to the electric toothbrush shown in FIG. 1;

FIG. 3 shows a side elevation view of an interproximal brush-head with a female snap connector for the electric toothbrush in FIG. 1;

FIG. 4 shows an end elevation view of the rotary brush-head shown in FIG. 2;

FIG. 5 shows a front elevation view of the toothbrush head shown in FIG. 2; and

FIG. 6 shows a front perspective view of a dispenser for a plurality of brush-heads for use in the system.

### DETAILED DESCRIPTION OF THE DRAWINGS

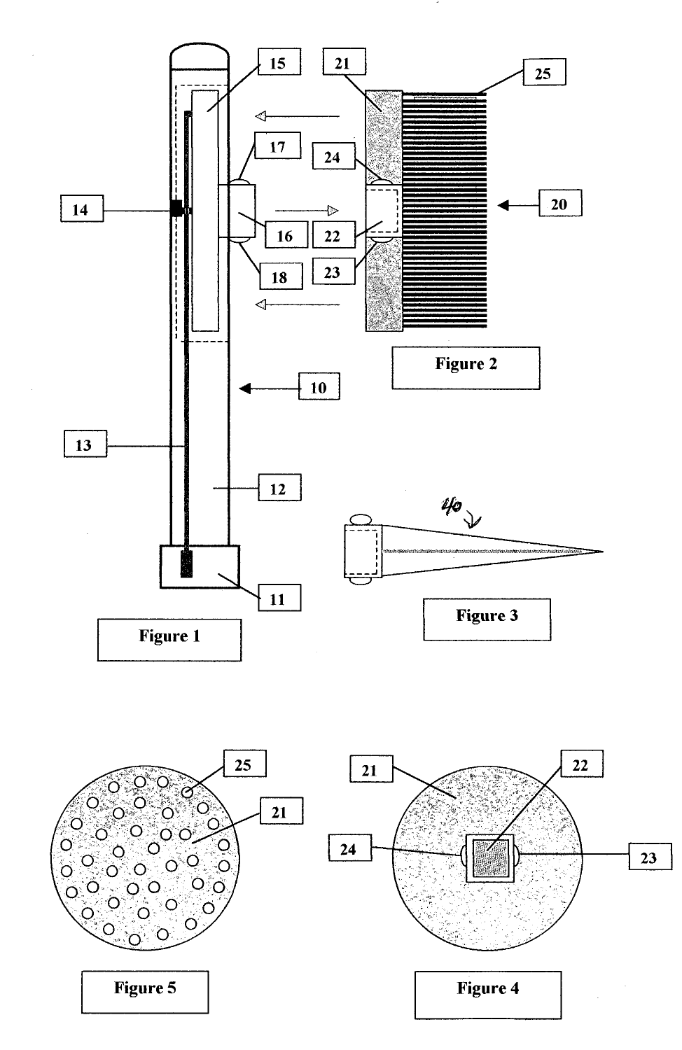

FIG. 1 shows electric toothbrush 10 for use in an embodiment of the system of this invention. Toothbrush 10 includes twist ring 11 for attaching the toothbrush to a motor (not shown) that oscillates or rotates the toothbrush head connector. Extending from twist ring 11 is brush housing head 12, and inside head 12, rotating shaft arm 13. Arm 13 connects to a base motor (not shown) through twist ring 11. Also connected to arm 13 is rotating snap friction disc plate 15. Attached to plate 15 is male snap friction connector 16 that includes retractable projections 17 and 18 at opposite ends. Bracket 14 holds shaft arm 13 and the parts connected thereto in the desired orientation within head 12.

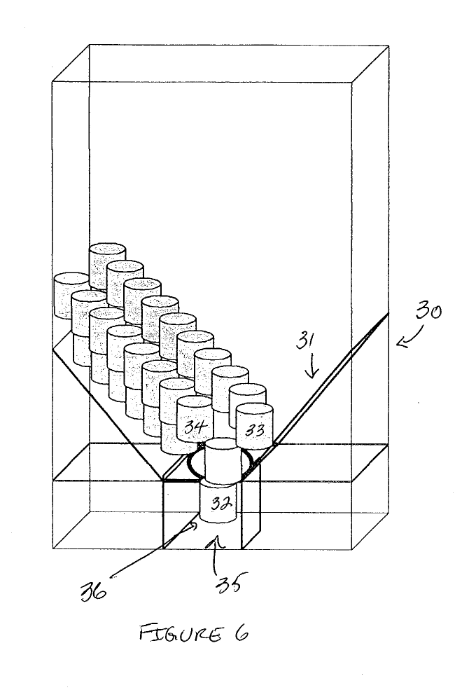

FIGS. 2, 4, and 5 show side elevation, rear elevation, and front elevation views, respectively, of brush head 20. Brush head 20 includes base plate 21 with female opening 22 including recesses 23 and 24. These recesses 23 and 24 are complementary in size and shape to projections 18 and 17, respectively, on toothbrush 10, permitting attachment to and detachment from head 12 after a single use. Connected to plate 21 on the side opposite opening 22 are a plurality of rounded soft bristles 25 that carry, e.g. are impregnated with, a dentifrice such as toothpaste.

FIG. 3 shows an interproximal brush head connector 40 for brushing interproximal areas in human teeth. Head 40 attaches to and detaches from connector 16 in the same way as head 20.

FIG. 6 shows brush head dispenser 30, of a four sided container having an internal funneling system 31 that delivers a plurality of brush heads 32, 33 and 34, one at a time, for user access through opening 35 in passageway 36.

1. A multi-part single-use toothbrush system comprises:
an electric toothbrush including a rotatable or oscillatable portion that includes a first connector for a disposable toothbrush head;
a plurality of disposable toothbrush heads, each with bristles having dentifrice sufficient for a single tooth-brushing use, and each including a second connector for attachment to and detachment from said electric toothbrush.

2. The system of claim 1 further comprising a dispenser for holding and dispensing said disposable toothbrush heads.

3. The system of claim 1 or claim 2 wherein said toothbrush connector can rotate or oscillate a toothbrush head through an arc of about 90° or through an arc of about 360°.
